(19) United States
(12) Patent Application Publication
(10) Pub. No.: US 2006/0017319 A1
(43) Pub. Date: Jan. 26, 2006

(54) Electrohydraulic brake system and method of monitoring it

(76) Inventors: Andreas Kohl, Mainz (DE); Rudiger Puff, Hunstetten-Wallbach (DE)

Correspondence Address: RATNERPRESTIA, P O BOX 980, VALLEY FORGE, PA, 19482-0980, US

(21) Appl. No.: 10/524,205

(22) PCT Filed: Aug. 9, 2003
(86) PCT No.: PCT/EP03/08872

§ 371 Date: Aug. 2, 2005

(30) Foreign Application Priority Data
Aug. 13, 2002 (DE) 10236973.9
Nov. 13, 2002 (DE) 10252728.8

(51) Int. Cl. B60T 13/18

(52) U.S. Cl. 303/11

(57) ABSTRACT

The present invention relates to an electrohydraulic brake system for motor vehicles of the ‘brake-by-wire’ type including a hydraulic pressure source that can be actuated by means of an electronic control unit and is comprised of a hydraulic pump driven by an electric motor and a high-pressure accumulator adapted to be recharged by the pump. Further, the invention relates to a method of monitoring an electrohydraulic brake system of the type mentioned hereinabove. To carry out a reliable detection of quantities of gas or air already when they enter the system, the invention discloses monitoring the suction side of the hydraulic pump. This is achieved in that the electric characteristic data of the electric motor driving the pump is analyzed so that any modification of the hydraulic delivery rate is detected.

### TECHNICAL FIELD

The present invention generally relates to an electrohydraulic brake system and more particularly relates to an electrohydraulic brake system for motor vehicles of the ‘brake-by-wire’ type including a hydraulic pressure source that can be actuated by means of an electronic control unit and is comprised of a hydraulic pump driven by an electric motor and a high-pressure accumulator adapted to be recharged by the pump.

### BACKGROUND OF THE INVENTION

German patent application DE 196 03 909 A1 discloses a method and a device for testing the brake system. In this arrangement, the quantity of the gases or air being undissolved in the pressure fluid is determined by that pressure in a wheel brake is increased and decreased in a defined fashion, and the gas content in the pressure fluid is determined from the time variation thereof. It is considered disadvantageous that the quantity of air or gases will only be detected after it has already entered the hydraulic system. It is considered another disadvantage of the prior art method that testing of the brake system can only be carried out during standstill of the vehicle.

### BRIEF SUMMARY OF THE INVENTION

In view of the above, an object of the invention is to indicate measures for testing a motor vehicle brake system of the type mentioned hereinabove, which allow detecting air or gases at an earliest possible point of time, such as already when they enter the system. Another objective is to enable testing of the brake system irrespective of its actuation and, hence, in the continuous operation of the motor vehicle.

According to the invention, this object is achieved by providing a means monitoring the hydraulic delivery rate of the pump for the purpose of detection of quantities of gas or air at the suction side of the pump.

To render the idea of the invention more precise, it is arranged for that monitoring the hydraulic delivery rate is executed by determining the electromotive force of the electric motor driving the hydraulic pump.

In a favorable improvement, monitoring the hydraulic delivery rate is achieved by determining the electric power consumption of the electric motor driving the hydraulic pump.

In another favorable improvement, monitoring the hydraulic delivery rate is achieved by determining the rotational speed of the electric motor driving the hydraulic pump.

In a low-cost favorable improvement, the rotational speed is determined from the electromotive force of the electric motor driving the pump. To this end, the invention provides that the actuating frequency of the electric motor preferably amounts to 25 hertz and that the time constant of the low-pass filter preferably amounts to 4 msec.

Further, the object is achieved according to the method in that quantities of gas or air at the suction side of the pump are detected by determining the hydraulic delivery rate of the pump.

### BRIEF DESCRIPTION OF THE DRAWINGS

FIG. 1 is a diagrammatic view of an electrohydraulic brake system wherein the method of the invention can be implemented.

FIG. 2a is a time variation of the voltage of an electric motor driving a pump that operates under load in normal operation.

FIG. 2b is a time variation of the voltage of an electric motor driving a freewheeling pump that does not operate under load.

### DETAILED DESCRIPTION OF THE PREFERRED EMBODIMENTS

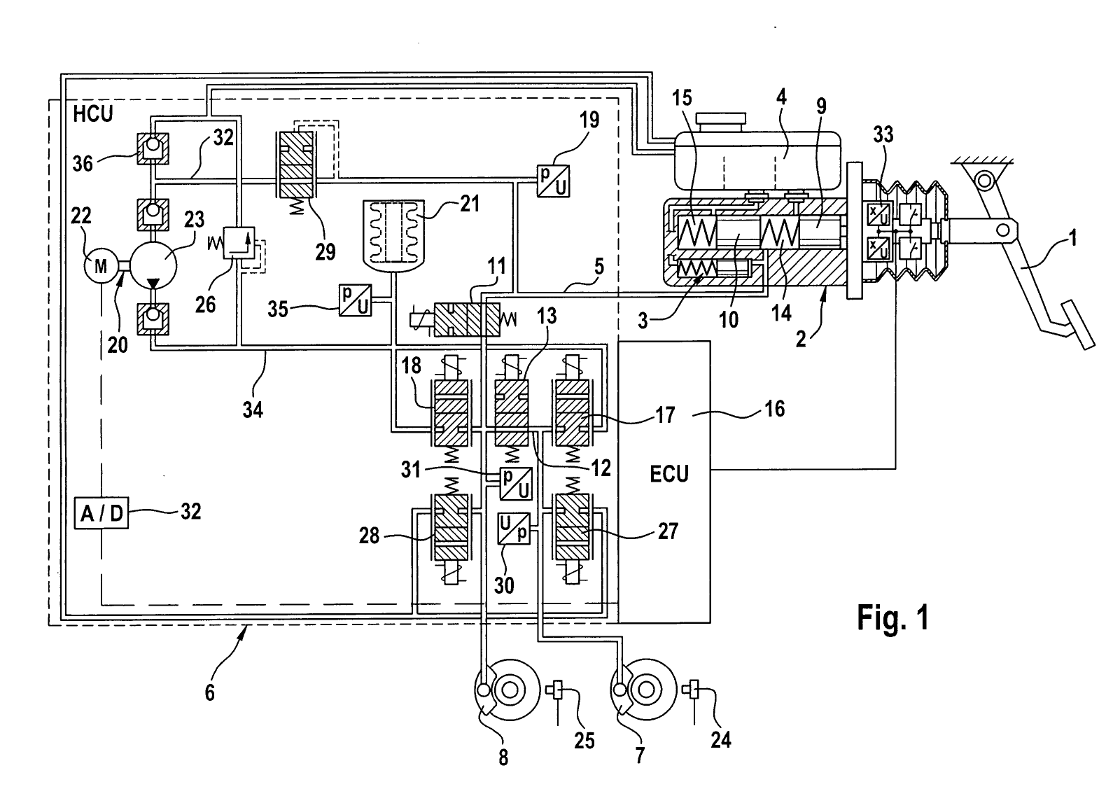

The brake system only represented in FIG. 1 is essentially composed of a dual-circuit hydraulic pressure generator or tandem-design master brake cylinder 2 that is operable by means of a brake pedal 1, a travel simulator 3 cooperating with the tandem master cylinder 2, a pressure fluid reservoir 4 associated with the tandem master cylinder 2, a hydraulic pressure source, a control unit HCU 6 (only represented) comprising among others all components necessary for pressure control operations and to which wheel brakes 7, 8 are connected that are e.g. associated with the rear axle of the motor vehicle, as well as an electronic control and regulation unit ECU 16. Wheel sensors 24, 25 (only hinted at) are used to determine the rotational speed of the vehicle wheels. The per se known tandem master cylinder 2 includes pressure chambers 14, 15 which are separated from each other and confined by two pistons 9, 10, said pressure chambers being connectible to both the pressure fluid supply reservoir 4 and, by way of HCU 6, to the vehicle brakes 7, 8 -, -. The above-mentioned pressure source is formed of a motor-pump assembly 20 comprising an electric motor 22 and a pump 23 driven by the electric motor 22, a pressure-limiting valve 26 connected in parallel to the pump, and a high-pressure accumulator 21 rechargeable by the pump 23. A pressure sensor 35 monitors the hydraulic pressure applied by the high-pressure accumulator 21.

As can further be taken from FIG. 1, the wheel brakes 7, 8 are connected to the first pressure chamber 14 by means of a conduit 5 containing a separating valve 11 that is configured as a normally open (NO) two-way/two-position directional control valve and allows closure of the first pressure chamber 14. A second hydraulic conduit 34 connects the pressure side of the pump 23 or the high-pressure accumulator 21 to the inlet ports of two preferably normally closed (NC) two-way/two-position directional control valves or inlet valves 17, 18 being electromagnetically operable, with analog control, and connected upstream of the wheel brakes 7 and 8. Another pair of preferably normally closed (NC) two-way/two-position directional control valves or outlet valves 27, 28 being likewise electromagnetically operable, with analog control, permit a connection between the wheel brakes 7, 8 and the pressure fluid reservoir 4, while an electromagnetically operable, preferably normally open (NO) pressure compensation valve 13 allows controlling the pressures introduced into the wheel brakes 7, 8 on each individual wheel.

In addition, pressure sensors 30, 31 are associated with the wheel brakes 7, 8 and serve to determine the hydraulic pressure prevailing in the wheel brakes 7, 8. The above-mentioned electronic control and regulation unit ECU 16, to which are sent the output signals of the pressure sensors 19, 30, 31, 35, of the wheel speed sensors 24, 25, and of a braking-request detection device 33 of a preferably redundant design and associated with the master brake cylinder 2, is used to actuate the motor-pump assembly 20 and the above-mentioned valves 11, 13, 17, 18, 27, 28.

The hydraulic control unit HCU 6 of the brake system described hereinabove, whose operation is known to the expert in the art, comprises an A/D converter 32 detecting the time variation of the voltage applied to the electric motor 22. The electric motor 22 is usually actuated with a relatively high frequency of 175 hertz, for example. The output signal of the A/D converter 32 is sent to the electronic control and regulation unit 16 and analyzed therein. To enable a perfect analysis, the output signal of the A/D converter 32 that shall be analyzed must be filtered because it is highly noise-infested due to the sparking that develops in the commutation. For this purpose, the ECU 16 includes a low-pass filter (not shown) whose time constant results from the so-called commutator sparking and preferably amounts to 4 msec. The electric motor 22 is then driven by a considerably lower frequency of preferably 25 hertz rather than by the above-mentioned comparatively high frequency.

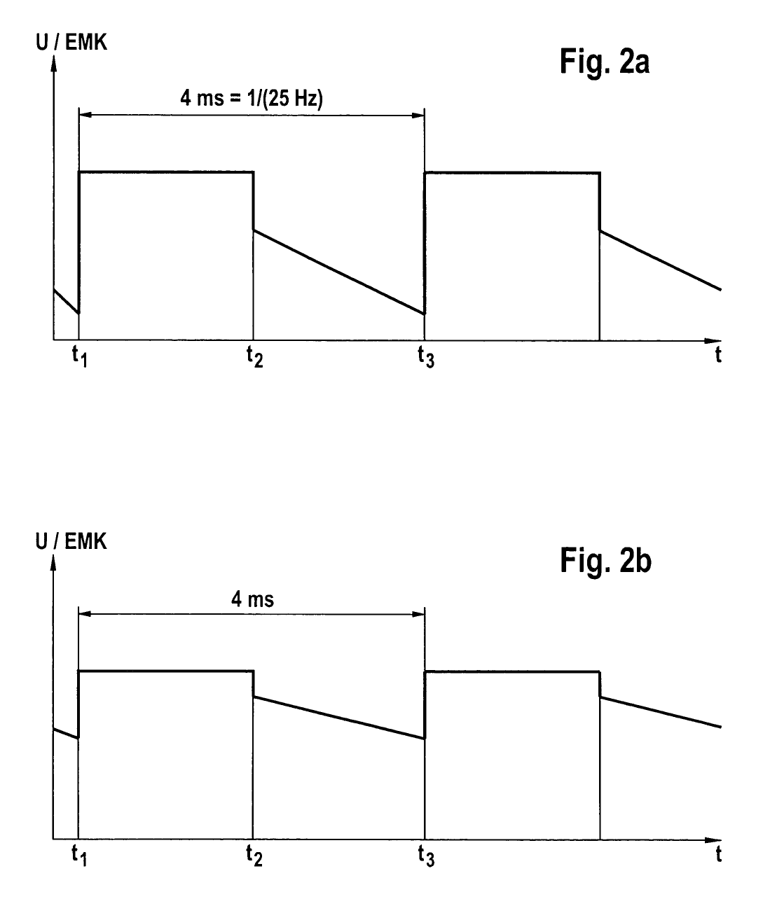

The course of the filtered signal illustrated in FIG. 2a shows that the electric motor 22 is operated at a constant voltage in the time interval between t₁ and t₂. In the time interval between t₂ and t₃ the electric motor continues by working on generator and produces an electromotive force. The characteristic variation of the electromotive force shown in the interval between t₂ and t₃ refers to the case where the electric motor drives a pump 23 operating under load and hence supplying exclusively pressure fluid into the system. In contrast thereto, FIG. 2b depicts in the interval between t₂ and t₃ the variation of the electromotive force of the electric motor 22, which drives a pump 23 that aspirates air or gases. To reliably detect the aspiration of air or gases, the electric motor 22 is constantly monitored by comparing present values of the electromotive force with values stored in the ECU 16 and representative of the desired load operation. Hence, the suction side of the pump is monitored during continuous operation of the motor vehicle.

A number of modifications can be realized within the scope of the invention. Thus, it is also possible to use the electrical power consumption of the electric motor driving the pump, instead of the electromotive force, as an indicator of the delivery rate of the pump. It is also feasible to use the rotational speed of the motor operated at a constant voltage as a characteristic quantity of the delivery rate of the pump.

1-14. (canceled)

15. A electrohydraulic brake system for motor vehicles of the ‘brake-by-wire’ type including a hydraulic pressure source that can be actuated by means of an electronic control unit and is comprised of a hydraulic pump driven by an electric motor and a high-pressure accumulator adapted to be recharged by the pump, wherein a means is provided monitoring the hydraulic delivery rate of the pump for the purpose of detection of quantities of gas or air at the suction side of the pump.

16. The electrohydraulic brake system as claimed in claim 15, wherein the hydraulic delivery rate is monitored by determining the electromotive force of the electric motor driving the hydraulic pump.

17. The electrohydraulic brake system as claimed in claim 15, wherein the hydraulic delivery rate is monitored by determining the electric power consumption of the electric motor driving the hydraulic pump.

18. The electrohydraulic brake system as claimed in claim 15, wherein the hydraulic delivery rate is monitored by determining the rotational speed of the electric motor driving the hydraulic pump.

19. The electrohydraulic brake system as claimed in claim 18, wherein the rotational speed is determined from the electromotive force of the electric motor driving the pump.

20. The electrohydraulic brake system as claimed in claim 15, wherein the actuating frequency of the electric motor preferably amounts to 25 hertz.

21. The electrohydraulic brake system as claimed in claim 15, wherein the time constant of the low-pass filter preferably amounts to 4 msec.

22. A method of monitoring an electrohydraulic brake system for motor vehicles of the ‘brake-by-wire’ type including a hydraulic pressure source that can be actuated by means of an electronic control unit and is comprised of a hydraulic pump driven by an electric motor and a high-pressure accumulator adapted to be recharged by the pump, wherein quantities of gas or air at the suction side of the pump are detected by determining the hydraulic delivery rate of the pump.

23. The method as claimed in claim 22, wherein the hydraulic delivery rate is determined by analyzing the electromotive force of the electric motor driving the pump.

24. The method as claimed in claim 22, wherein the hydraulic delivery rate is determined by analyzing the electric power consumption of the electric motor driving the pump.

25. The method as claimed in claim 22, wherein the hydraulic delivery rate is determined by analyzing the rotational speed of the electric motor driving the pump.

26. The method as claimed in claim 22, wherein the rotational speed of the electric motor driving the pump is determined from the electromotive force of the electric motor.

27. The method as claimed in claim 22 wherein the actuating frequency of the electric motor preferably amounts to 25 hertz.

28. The method as claimed in claim 22, wherein the time constant of the low-pass filter preferably amounts to 4 msec.
